(19) United States
(12) Patent Application Publication
(10) Pub. No.: US 2001/0034725 A1
(43) Pub. Date: Oct. 25, 2001

(54) Electronic payment system and method using anonymous representative payment means

(75) Inventors: Hong-Kyu Park, Seoul (KR); Chong-mok Park, Seoul (KR); Moon-giu Suh, Seoul (KR)

Correspondence Address: THE LAW OFFICES OF, EUGENE M. LEE, P.L.L.C., 2111 WILSON BOULEVARD, SUITE 1200, ARLINGTON, VA, 22201, US

(73) Assignee: Allat Corporation

(21) Appl. No.: 09/805,429

(22) Filed: Mar. 14, 2001

(30) Foreign Application Priority Data
Mar. 14, 2000 (KR) 00-12630

(51) Int. Cl. G06F 17/60

(52) U.S. Cl. 705/79

(57) ABSTRACT

An electronic payment system and method with an anonymous represent payment card is provided which ensure the anonymity of a client and are available for electronic commerce and real transactions. The electronic payment system includes: an electronic payment web server connected to a client terminal through the Internet, for providing an identification number and password to a client who applies for a registration, providing a representative payment card to the client who applies for the card, and downloading an electronic wallet driving program to an web browser of the client terminal; and a payment gateway server connected to the electronic payment web server by a leased line, for receiving a representative payment card issued by a financial system of a financial company and to be provided through the electronic payment web server to the client who applies for the card, incorporating the identification number of the representative payment card into an electronic wallet corresponding to the client's identification number, receiving a client's product purchase information from the electronic wallet driving program downloaded to the client terminal, requesting an approval for payment with the representative payment card to the financial system in response to a payment approval request from an Internet shopping mall server, and informing the Internet shopping mall server of the result of payment approval request from the financial system. The client's authentication is achieved by the identification number and password, so that the representative payment means can be used in affiliated electronic commerce shops with secured anonymity. The representative payment card can be efficiently used in existing credit card-affiliated shops using its identification number.

### BACKGROUND OF THE INVENTION

1. Field of the Invention

The present invention relates to an electronic payment system, and more particularly, to an electronic payment system and method which can be used in electronic commerce and real transactions, using an anonymous representative payment means.

2. Description of the Related Art

One of the important factors which should be considered for promotion of electronic commerce through the Internet is safe payment. Recently, various electronic payment systems are being developed for safe payment through networks. These electronic payment systems can be divided into an electronic money type and a payment broker type.

In the electronic money method, money is issued in the form of digital information and this digital information is used as payment means. That is, according to the electronic money method, a client receives electronic money, which is electronic information issued by a financial company such as a bank, based on the balance in the client's account or his credit, and pays the electronic money directly to a receiver. Leading electronic money systems include eCash of Digicash, Cyber Cash of CyberCash in designed to be implemented by a network, and Mondex card of Mondex, and Visa Cash of Visa International in taking the form of an IC card. According to the electronic payment system using electronic money, a seller cannot know a client's personal information (anonymity), cannot revoke an electronic money transaction (irrevocability), can carry the electronic money in an electronic wallet after withdrawing a predetermined amount of money from a bank (portability), and can withdraw, pay, or deposit electronic money (bidirectional nature). However, since the payment system using electronic money has the characteristic of anonymity, information needed in marketing, such as buying tendencies of clients, cannot be collected. Since a client can do business only with those sellers who are member shops of a predetermined electronic money system, the number and variety of the shops in which the client can use electronic money are limited. In addition, electronic money is only appropriate for small transactions due to the problems of safety and reliability.

Unlike the forgoing, the payment broker system, in which money is paid using a user's credit card or by transferring money between accounts, needs a broker (for example, a credit card company) who mediates payment so that a buyer can safely pay money to a user for a transaction. That is, in the payment broker system, credit cards used in the real word are applied to electronic commerce. Sellers can deliver products without worries because a credit card company guarantees the payment for the products, and this in turn promotes electronic commerce on the Internet where both parties of a transaction cannot easily check the other's credit. However, since the payment broker system needs some compensation for maintaining the system, the system is generally only used for relatively large transactions, and is not appropriate for small transactions. In addition, since the Internet is an open network, personal information can be leaked unless a special security system is constructed.

### SUMMARY OF THE INVENTION

To solve the above problems, it is an object of the present invention to provide an electronic payment system and method in which the anonymity of a client is guaranteed, the already established infrastructure of credit card-affiliated shops can be efficiently utilized, and a representative payment means which can be used both in electronic commerce and in real transactions is used.

According to an aspect of the present invention, there is provided an electronic payment system using an anonymous representative payment means issued by a financial company in an Internet shopping mall affiliated with the financial company, the electronic payment system comprising: an electronic payment web server connected to a client terminal through the Internet, for providing an identification number and password to a client who applies for a registration, providing a representative payment means to the client who applies for the card, and downloading an electronic wallet driving program to an web browser of the client terminal; and a payment gateway server connected to the electronic payment web server by a leased line, for receiving a representative payment means issued by a financial system of the financial company and to be provided through the electronic payment web server to the client who applies for the card, incorporating the identification number of the representative payment means into an electronic wallet corresponding to the client's identification number, receiving a client's product purchase information from the electronic wallet driving program downloaded to the client terminal, requesting an approval for payment with the representative payment means to the financial system in response to a payment approval request from an Internet shopping mall server, and informing the Internet shopping mall server of the result of payment approval request from the financial system.

The present invention provides an electronic payment system using an anonymous representative payment means issued by a financial company in an Internet shopping mall which not affiliated with the financial company, the electronic payment system comprising: an electronic payment web server connected to a client terminal through the Internet, for providing an identification number and password to a client who applies for a registration, providing a representative payment means to the client who applies for the card, and downloading an electronic wallet driving program to an web browser of the client terminal; and a payment gateway server connected to the electronic payment web server by a leased line, for receiving a representative payment means issued from a financial system of the financial company and to be provided through the electronic payment web server to the client who applies for the card, incorporating the identification number of the representative payment means into an electronic wallet corresponding to the client's identification number, receiving and authenticating a client identification number and password from the electronic wallet driving program downloaded to the client terminal to transfer client profile information including the identification number of the representative payment means, which is stored in the electronic wallet of the authenticated client, to the electronic wallet driving program, so that the client profile information is automatically displayed in an input box for payment means information provided by the Internet shopping mall server.

According to another aspect of the present invention, there is provided an electronic payment method using an anonymous representative payment means issued from a financial company in an Internet shopping mall affiliated with the financial company, the electronic payment method comprising: (a) providing a identification number and password to a client who applies a registration; (b) receiving a representative payment means issued from a financial system of the finance company and incorporating the identification number of the representative payment means into an electronic wallet corresponding to the client's identification number; (c) downloading an electronic wall driving programing to an web browser on a client terminal if the client requests for the download; (d) receiving and authenticating the identification number and password from the electronic wallet driving program; and (e) receiving a client's product purchase information from the electronic wallet driving program, and requesting an approval for payment with the representative payment means to the financial system in response to a payment approval request from the Internet shopping mall, and informing the Internet shopping mall of the result of payment approval request from the financial system.

The present invention provides an electronic payment method using an anonymous representative payment means issued from a financial company in an Internet shopping mall which is not affiliated with the financial company, the electronic payment method comprising: (a) providing a identification number and password to a client who applies a registration; (b) receiving a representative payment means issued from a financial system of the finance company and incorporating the identification number of the representative payment means into an electronic wallet corresponding to the client's identification number; (c) downloading an electronic wall driving programing to an web browser on a client terminal if the client requests for the download; (e) receiving and authenticating a client identification number and password from the electronic wallet driving program downloaded to the client terminal to transfer client profile information including the identification number of the representative payment means, which is stored in the electronic wallet of the authenticated client, to the electronic wallet driving program, so that the client profile information is automatically displayed in an input box for payment means information provided by the Internet shopping mall server.

### BRIEF DESCRIPTION OF THE DRAWINGS

The above object and advantages of the present invention will become more apparent by describing in detail preferred embodiments thereof with reference to the attached drawings in which:

FIG. 1 illustrates the procedure of issuing and providing a representative payment means in an electronic payment system according to a preferred embodiment of the present invention;

FIG. 2 shows an example of the screen for membership registration in the electronic payment system according to the present invention;

FIG. 3 shows an example of the screen for card application;

FIG. 4 illustrates the electronic payment procedure according to a preferred embodiment of the present invention;

FIG. 5 illustrates the electronic payment procedure according to another preferred embodiment of the present invention; and

FIG. 6 illustrates the electronic payment procedure according to still another preferred embodiment of the present invention.

### DETAILED DESCRIPTION OF THE INVENTION

The present invention will now be described in detail with reference to the accompanying drawings.

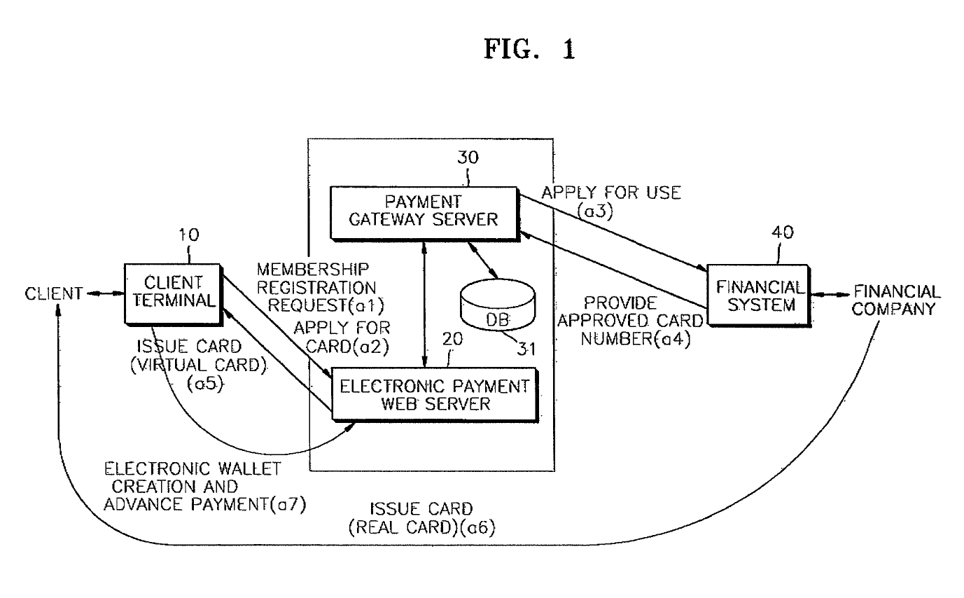

FIG. 1 shows the procedure of a client being issued with a representative payment means in an electronic payment system using an anonymous representative payment means, illustrating the data flow among a client terminal 10, an electronic payment web server 20, a payment gateway server 30 and a financial system 40, for the client to be issued with the representative payment means. In the present invention, the electronic payment web server 20 and the payment gateway server 30 are termed to mean a software for providing the corresponding services under the Internet-linked environment and a computer system for implementing the software.

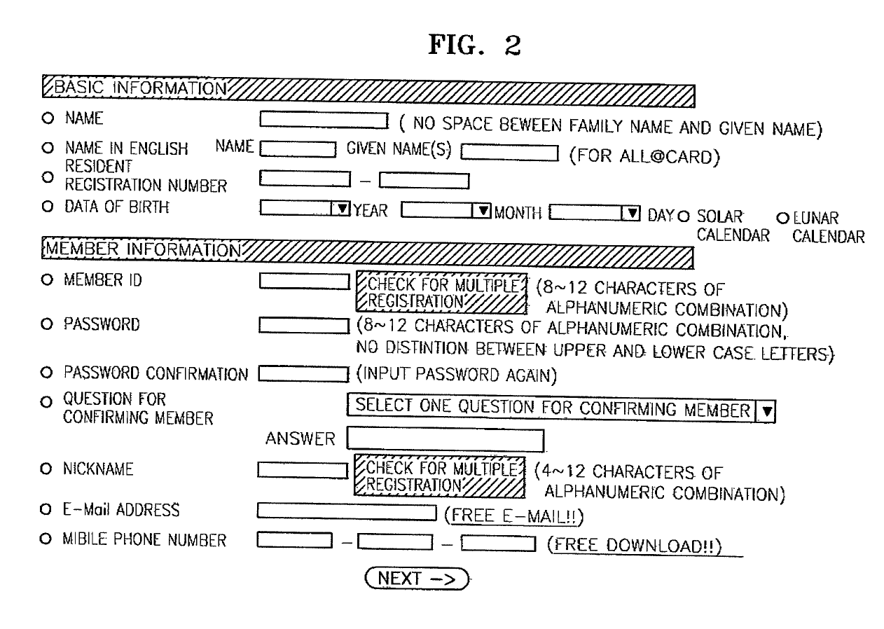

First, the client connects to the electronic payment web server 20 through the Internet using a web browser working on the client terminal 10. Here, the Internet refers to a computer communications network for connecting Transmission Control Protocol/Internet Protocol (TCP/IP) users worldwide. The client may select a web page for membership registration, as shown in FIG. 2, among web pages provided by the electronic payment web server 20, to apply for membership registration (step a1). In the registration step, the client enters his/her basic information, such as Name, Name in English, Resident registration number and Date of Birth, and then selects the item of member information, such as member identification number (ID) or password, for registration. Referring to FIG. 2, the member information preferably further include such items as the nickname that can be used instead of the ID used as the payment means on other web sites provided by the electronic payment web server 20, e-mail address and mobile phone number. Also, the member confirmation question, which is necessary for reissuing member ID and password in the case where the client forgets his/her ID or password, is one selected by the client among questions; for example, “What is the book that is most recommendable to your friends?”, “What is the nickname of your elementary school teacher to whom you have the best impression?”, “When is your parents' wedding anniversary?”, “Who do you respect most?”, “What is your favorite Chinese expression?” and so on. Further, the client's response to the question is preferably included in the items of the member information. The electronic payment web server 20 transfers the client's entered basic information and member information to the payment gateway server 30 to then be stored in a database 31.

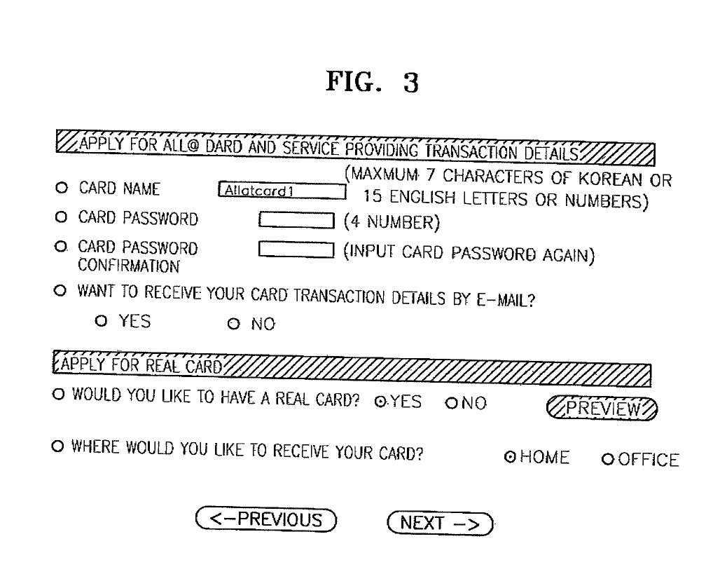

Then, the client who has completed the registration procedure (to be referred to as “registered client” hereinafter) selects the web page for card application, as shown in FIG. 3, among web pages provided by the electronic payment web server 20, to then request the issuance of a representative payment means (referred to as “All@card” in the drawing) (step a2). In a first embodiment of the present invention, any type of payment means that has an anonymous property and is rechargeable, can be used as the representative payment means. However, it is assumed that a prepaid card is used as the representative payment means throughout the description below. If the registered client selects and enters the Card name and security number for identifying the client's own prepaid card through the web browser of the client terminal 10, the electronic payment web server 20 transfers the entered information for card application to the payment gateway server 30. Then, the payment gateway server 30 fetches the basic information and member information stored in the database 31 to create the information for application for card use along with the information for card application. Next, the payment gateway server 30 accesses a financial system 40 of its affiliated financial company to transfer the information for application for card use (step a3) and gains the financial company's approval for card use and is provided with the identification number (card number) of the representative payment means from the financial system 40 (step a4). Then, the electronic payment web server 20 issues the prepaid card based on the card number to the registered client (step a5). In step a4, the payment gateway server 30 creates an electronic wallet corresponding to the member ID and having the approved card number included therein and stores it in the database 31. The electronic payment web server 20 preferably transfers the identification number (card number) of the newly issued representative payment means to the client by e-mail.

The prepaid card issued in the prepaid card issuing step is classified as either a virtual card, only the number of which is communicated to the registered client, or a real card, the number of which is communicated to the registered client and which is directly mailed to the registered client. Therefore, when the registered client applies for the real card on the web page for the application of the real card, provided by the electronic payment web server 20, as shown in FIG. 3, the application contents are transferred to the person in charge at the final company through the electronic payment web server 20, the payment gateway server 30 and the financial system 40. If the use approval is gained in step a4, the person issues the real card to the registered client and delivers the same to the delivery place designated by the client (step a6).

The registered client to whom the prepaid card has been issued, must charge the prepaid card first to use the same (step a7). Here, the charging system used includes a cash charge system, an account transfer charging system, a credit card based charging system and the like. In the credit card based charging system, not only a credit card provided by the financial company that issued the prepaid card but also a credit card provided by another financial company, may be used to charge the prepaid card. Also, the electronic wallet created in step a4, may include at least one representative payment means related to the corresponding client, credit card number and account number. The representative payment means, that is, the prepaid card, can be directly charged from the amount remaining on the credit card or account, whose information is included in the electronic wallet. In the case where the credit card provided by a financial company other than the financial company that issued the prepaid card is included in the electronic wallet, the payment gateway server 30 is connected to the financial system (not shown) of the corresponding financial company to authenticate the credit card.

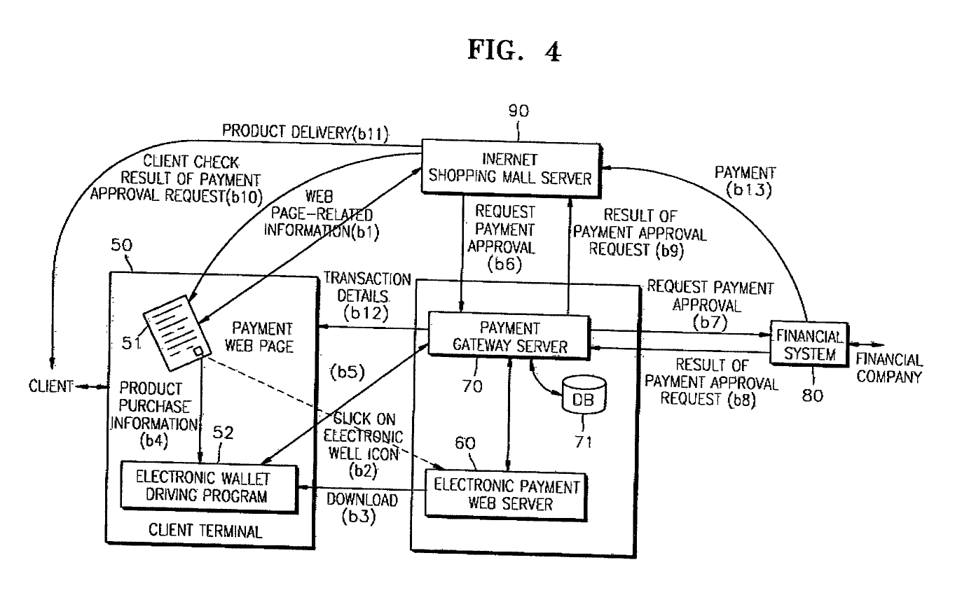

FIG. 4 shows the procedure of payment for a product purchased from an affiliated Internet shopping mall in an electronic payment system using an anonymous prepaid card according to a first embodiment of the present invention, illustrating the data flow, among a client terminal 50, an electronic payment web server 60, a payment gateway server 70, a financial system 80 and an Internet shopping mall server 90, for payment. The client terminal 50, the electronic payment web server 60, the payment gateway server 70 and the financial system 80 correspond to the client terminal 10, the electronic payment web server 20, the payment gateway server 30 and the financial system 40 shown in FIG. 1, respectively. The client terminal 50 and the Internet shopping mall server 90, the client terminal 50 and the electronic payment web server 60, the client server 50 and the payment gateway server 70, and the Internet shopping mall server 90 and the payment gateway server 70, are preferably connected to each other through the Internet. The payment gateway server 70 and the financial system 80 are connected to each other by a separate leased line.

First, the client connects to the Internet shopping mall server 90 through the Internet using the web browser operating on the client terminal 50. The client selects the products to be purchased from the web pages provided by the Internet shopping mall server 90 and elects to perform payment through a payment web page 51 supplied by the Internet shopping mall web server 90 (step b1). Here, the Internet shopping mall server 90 uses an electronic payment system according to the first embodiment of the present invention. The payment web page 51 includes an electronic wallet icon to call the electronic payment web server 60 provided in the electronic payment system.

If the client selects the electronic wallet icon (step b2), the electronic payment web server 60 downloads an electronic wallet driving program 52 by which an electronic wallet can be driven, on the web browser of the client terminal 50. When the downloaded electronic wallet driving program 52 is executed on the web browser of the client terminal 50, a hacking preventing program is preferably installed. The executed electronic wallet driving program 52 receives product purchase information, such as the identifier of the Internet shopping mall server 90, the identifier of the client on the Internet shopping mall server 90, the client's selected product list and so on, from the payment web page 51 (step b4).

If the client inputs the member ID and password registered in step a1 of FIG. 1 to the electronic wallet driving program 52, the electronic wallet driving program 52 transfers the client's input ID and password to the payment gateway server 70, and then the payment gateway server 70 authenticates the client using the received information. The client can perform direct management, including charging the prepaid card included in his/her electronic wallet by the electronic wallet driving program 52, or adding or deleting other cards or accounts. The electronic wallet driving program 52 transfers the information related to client's selection of one among a number of prepaid cards and the product purchase information received in step b4 (step b5). The payment gateway server 70 temporarily stores the received product purchase information in the database 71 for payment. In the first embodiment of the present invention, for the purpose of ensuring the security of the electronic wallet driving program 52 and the payment gateway server 70, Data Encryption Standard (DES), Riverst-Shamir-Adleman (RSA) and Message Digest 5 (MD5) methods are comprehensively used.

Then, the Internet shopping mall server 90 requests the payment gateway server 70 for payment approval (step b6). The payment approval request includes the identifier of the Internet shopping mall server 90, the identifier of the client on the Internet shopping mall server 90, the client's selected product list and so on. Here, since the client information is not included in the payment approval request, it is free from danger of being divulged over the Internet, which is an open network. The payment gateway server 70 fetches the product purchase information corresponding to the payment approval request received in step b6 to the database 71, compares the two pieces of information, and only when there is no inconsistency, the payment gateway server 70 requests the financial system 80 for payment approval using the client's prepaid card selected in step b5 (step b7).

The financial system 80 checks the amount remaining on the prepaid card request for payment approval, deducts the total purchase price from the remaining amount if the total purchase price of the product for which payment approval is requested is within the limit of the remaining amount, and transfers the result of the payment approval request to the payment gateway server 70 (step b8). The payment gateway server 70 transfers the result to the Internet shopping mall server 90 (step b9). The Internet shopping mall server 90 allows the client to confirm the payment approval result through the web browser of the client terminal 50 (step b10).

The Internet shopping mall operator delivers the paid product to the client (step b11). The payment gateway server 70 transfers transaction details collectively to the client on the next day of the transaction date by e-mail or mobile phone terminal (step b12). Next, the Internet shopping mall operator demands payment to the financial company, and then the steps of electronic payment performed by the electronic payment system using an anonymous prepaid card according to the first embodiment of the present invention are completed upon payment by the financial company (step b13).

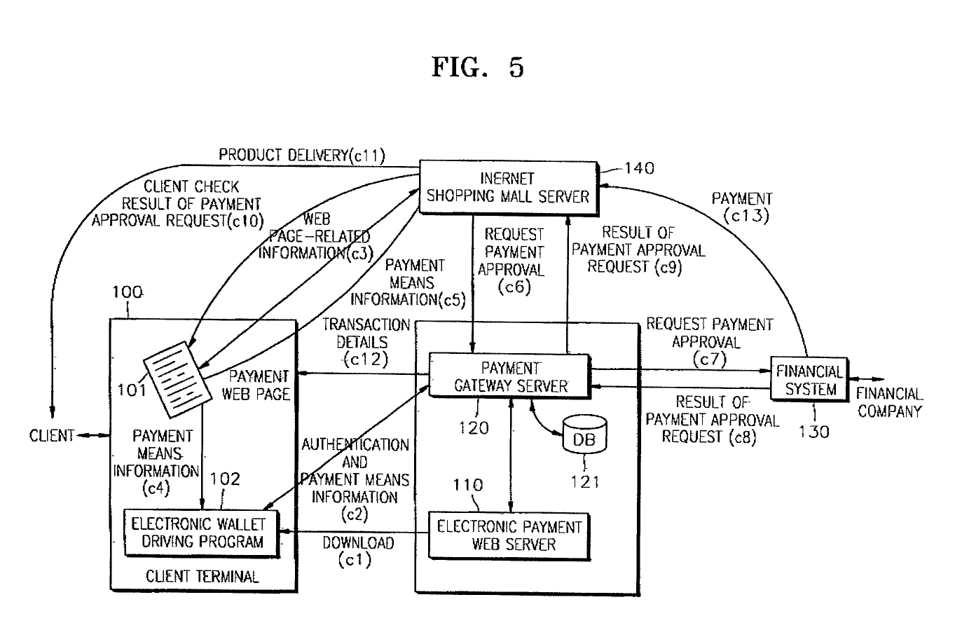

FIG. 5 shows the procedure of payment for a product purchased from an affiliated Internet shopping mall in an electronic payment system using an anonymous prepaid card according to a second embodiment of the present invention, illustrating the data flow, among a client terminal 100, an electronic payment web server 110, a payment gateway server 120, a financial system 130 and an Internet shopping mall server 140, for payment. The client terminal 100, the electronic payment web server 110 and the payment gateway server 120 correspond to the client terminal 10, the electronic payment web server 20, the payment gateway server 30 and the financial system 40 shown in FIG. 1, respectively. The client terminal 100 and the Internet shopping mall server 140, the client terminal 100 and the electronic payment web server 110, the client server 100 and the payment gateway server 120, and the Internet shopping mall server 140 and the payment gateway server 120, are preferably connected to each other through the Internet. The payment gateway server 120 and the financial system 130 are connected to each other by a separate leased line.

First, the client connects to the electronic payment web server 110 through the Internet using the web browser operating on the client terminal 100 to download an electronic wall driving program 102 (step c1). When the downloaded electronic wallet driving program 102 is executed on the web browser of the client terminal 100, a hacking preventing program is preferably installed.

If the client inputs the member ID and password registered in step a1 of FIG. 1 to the electronic wallet driving program 102, the electronic wallet driving program 102 transfers the client's input ID and password to the payment gateway server 120, and then the payment gateway server 120 authenticates the client using the received information (step c2). In the second embodiment of the present invention, for the purpose of ensuring the security of the electronic wallet driving program 102 and the payment gateway server 120, Data Encryption Standard (DES), Riverst-Shamir-Adleman (RSA) and Message Digest 5 (MD5) methods are comprehensively used.

Then, the client connects to the Internet shopping mall server 140 through the Internet using the web browser operating on the client terminal 100. The client selects the products to be purchased from the web pages provided by the Internet shopping mall server 140 and elects to perform payment through a payment web page 101 supplied by the Internet shopping mall web server 140 (step c1). Here, the client selects one among a number of prepaid cards included in the client's electronic wallet managed by the payment gateway server 120 through the electronic wallet driving program 102, receives payment means information managed in the database 121, that is, the type, serial number, secrete number of the selected card, client information for authentication and so on, from the payment gateway server 120 (step c2), automatically writes the information on the payment web page 101 (step c4) and then transfers the same to the Internet shopping mall server 140 (step c5). Here, the client can directly input the payment means information, including the number of the issued prepaid card, on the input box for the payment means information, irrespective of the electronic wallet driving program 102.

Then, the Internet shopping mall server 140 requests the payment gateway server 120 for payment approval (step c6). The payment approval request in step c6 includes the identifier of the Internet shopping mall server 140, the identifier of the client on the Internet shopping mall server 140, the client's selected product list, the serial number and secrete number of the prepaid card, the client's profile information and so on. The payment gateway server 120 compares the client's profile information corresponding to the payment approval request received in step c6 with the serial number and secrete number of the prepaid card, the registered client's profile information, managed by the database 171, and requests the financial system 130 for payment approval to only when there is no inconsistency (step c7).

The financial system 130 checks the amount remaining on the prepaid card for which payment approval is requested, deducts the total purchase price from the remaining amount if the total purchase price of the product for which payment approval is requested is within the limit of the remaining amount, and transfers the result of the payment approval request to the payment gateway server 120 (step c8). The payment gateway server 120 transfers the result to the Internet shopping mall server 140 (step c9). The Internet shopping mall server 140 allows the client to confirm the payment approval result through the web browser of the client terminal 100 (step c10).

The Internet shopping mall operator delivers the paid product to the client (step c11). The payment gateway server 70 transfers transaction details collectively to the client on the next day following the transaction date by e-mail or mobile phone terminal (step c12). Next, the Internet shopping mall operator demands payment from the financial company, and then the steps of electronic payment performed by the electronic payment system using an anonymous prepaid card according to the second embodiment of the present invention are completed upon payment by the financial company (step c13).

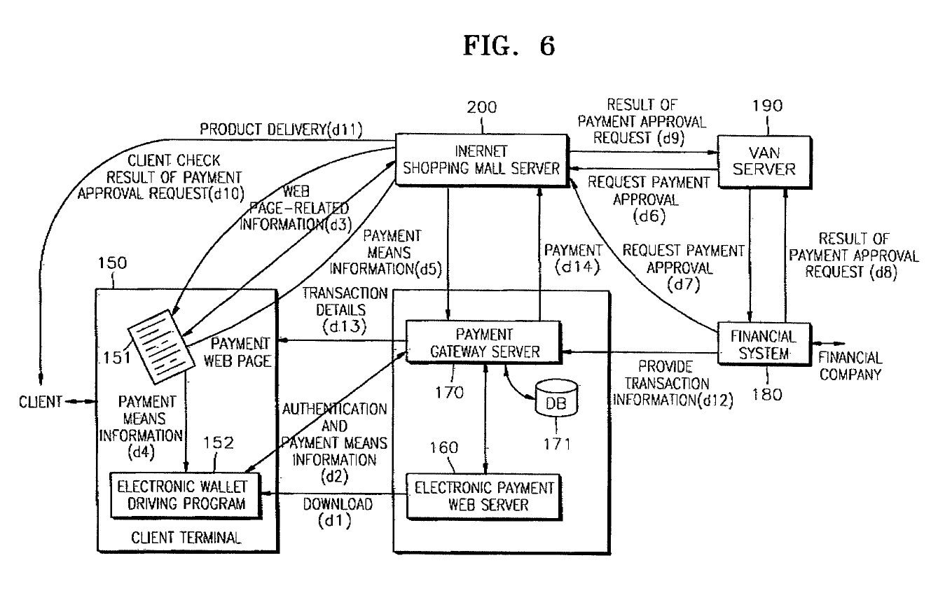

FIG. 6 shows the procedure of payment for a product purchased from an affiliated Internet shopping mall in an electronic payment system using an anonymous prepaid card according to a third embodiment of the present invention, illustrating the data flow, among a client terminal 150, an electronic payment web server 160, a payment gateway server 170, a financial system 180, a VAN server 190 and an Internet shopping mall server 200, for payment. The client terminal 150, the electronic payment web server 160, the payment gateway server 170 and the financial system 180 correspond to the client terminal 10, the electronic payment web server 20, the payment gateway server 30 and the financial system 40 shown in FIG. 1, respectively. The client terminal 150 and the Internet shopping mall server 200, the client terminal 150 and the electronic payment web server 160, the client server 150 and the payment gateway server 170, and the Internet shopping mall server 200 and the payment gateway server 170, are preferably connected to each other through the Internet. The payment gateway server 170 and the financial system 180 are connected to each other by a separate leased line.

First, the client connects to the electronic payment web server 160 through the Internet using the web browser operating on the client terminal 150 to download an electronic wallet driving program 152 (step dl). When the downloaded electronic wallet driving program 152 is executed on the web browser of the client terminal 150, a hacking preventing program is preferably installed. The executed electronic wallet driving program 152 receives the member ID and password registered in step a1 of FIG. 1, the electronic wallet driving program 152 transfers the client's input ID and password to the payment gateway server 170, and then the payment gateway server 170 authenticates the client using the received information (step d2). In the third embodiment of the present invention, for the purpose of ensuring the security of the electronic wallet driving program 102 and the payment gateway server 120, Data Encryption Standard (DES), Riverst-Shamir-Adleman (RSA) and Message Digest 5 (MD5) methods are comprehensively used.

Then, the client connects to the Internet shopping mall server 200 through the Internet using the web browser operating on the client terminal 150. The client selects the products to be purchased from the web pages provided by the Internet shopping mall server 200 and elects to perform payment through a payment web page 151 supplied by the Internet shopping mall web server 140 (step d1). Here, the client selects one among a number of prepaid cards included in the client's electronic wallet managed by the payment gateway server 170 through the electronic wallet driving program 152, receives payment means information managed in the database 171, that is, the type, serial number, secrete number of the selected card, client information for authentication and so on, from the payment gateway server 170 (step d2), to be automatically written on the payment web page 151 (step d4) and then be transferred to the Internet shopping mall server 200 (step d5). Here, the client can directly input the payment means information, including the number of the issued prepaid card, on the input box for the payment means information, irrespective of the electronic wallet driving program 152.

Then, the Internet shopping mall server 200 requests the VAN server 190 for payment approval for the products ordered by the client (step d6). The payment approval request in step d6 includes the identifier of the Internet shopping mall server 200, the identifier of the client on the Internet shopping mall server 200, the client's selected product list, the serial number and secrete number of the prepaid card, the client's profile information and so on. Then, the VAN server 190 requests the financial system 180 for payment approval (step d7).

The financial system 180 checks the amount remaining on the prepaid card request for payment approval, deducts the total purchase price from the remaining amount if the total purchase price of the product for which payment approval is requested is within the limit of the remaining amount, and transfers the result of the payment approval request to the VAN server 190 (step d8). The VAN server 190 transfers the result to the Internet shopping mall server 200 (step d9). The Internet shopping mall server 200 allows the client to confirm the payment approval result through the web browser of the client terminal 150 (step d10).

The Internet shopping mall operator delivers the paid product to the client (step d11). The financial system 180 transfers transaction details to the payment gateway server 120 (step d12). The payment gateway server 120 collectively transfers the transaction details to the client on the next day following the transaction date by e-mail or mobile phone terminal (step d13). Next, the Internet shopping mall operator demands payment from the financial company, and the steps of electronic payment performed by the electronic payment system using an anonymous prepaid card according to the third embodiment of the present invention are completed upon payment by the financial company (step d14).

The real card issued in step a6 of FIG. 1 can also be used in general credit card member shops, and the payment thereof is processed in a manner similar to that shown in FIG. 6, by replacing the Internet shopping mall server 200 by a real credit card member shop.

Although certain preferred embodiments have been shown and described, it will be understood that many changes and modifications may be made thereto without departing from the scope and intent of the appended claims. Therefore, the disclosed embodiments should be considered as being provided for a descriptive purpose only and should not be construed as limiting the present invention. It is therefore contemplated that the present invention shall cover any and all modifications, variations, or equivalents that fall within the spirit and scope of the basic underlying principles disclosed and claimed herein.

What is claimed is:

1. An electronic payment system using an anonymous representative payment means issued by a financial company in an Internet shopping mall affiliated with the financial company, the electronic payment system comprising:
an electronic payment web server connected to a client terminal through the Internet, for providing an identification number and password to a client who applies for a registration, providing a representative payment means to the client who applies for the card, and downloading an electronic wallet driving program to an web browser of the client terminal; and
a payment gateway server connected to the electronic payment web server by a leased line, for receiving a representative payment means issued by a financial system of the financial company and to be provided through the electronic payment web server to the client who applies for the card, incorporating the identification number of the representative payment means into an electronic wallet corresponding to the client's identification number, receiving a client's product purchase information from the electronic wallet driving program downloaded to the client terminal, requesting an approval for payment with the representative payment means to the financial system in response to a payment approval request from an Internet shopping mall server, and informing the Internet shopping mall server of the result of payment approval request from the financial system.

2. The electronic payment system of claim 1, wherein the representative payment means is a prepaid card.

3. The electronic payment system of claim 1, wherein a client's credit card number or bank account number is further incorporated into the electronic wallet, the representative payment means is charged by the client's credit card or from the client's bank account.

4. The electronic payment system of claim 1, wherein the electronic wallet driving program is installed on the web browser of the client terminal, is authenticated by the payment gateway server by the client's identification number and password, and transfers the client's product purchase information received from the web page of the Internet shopping mall on the client's web browser to the payment gateway server.

5. The electronic payment system of claim 1, wherein the payment gateway server further comprises means for transferring transaction details to the client after informing the Internet shopping mall server of the result of payment approval request from the financial system.

6. An electronic payment system using an anonymous representative payment means issued by a financial company in an Internet shopping mall which not affiliated with the financial company, the electronic payment system comprising:
an electronic payment web server connected to a client terminal through the Internet, for providing an identification number and password to a client who applies for a registration, providing a representative payment means to the client who applies for the card, and downloading an electronic wallet driving program to an web browser of the client terminal; and
a payment gateway server connected to the electronic payment web server by a leased line, for receiving a representative payment means issued from a financial system of the financial company and to be provided through the electronic payment web server to the client who applies for the card, incorporating the identification number of the representative payment means into an electronic wallet corresponding to the client's identification number, receiving and authenticating a client identification number and password from the electronic wallet driving program downloaded to the client terminal to transfer client profile information including the identification number of the representative payment means, which is stored in the electronic wallet of the authenticated client, to the electronic wallet driving program, so that the client profile information is automatically displayed in an input box for payment means information provided by the Internet shopping mall server.

7. An electronic payment method using an anonymous representative payment means issued from a financial company in an Internet shopping mall affiliated with the financial company, the electronic payment method comprising:
(a) providing a identification number and password to a client who applies a registration;
(b) receiving a representative payment means issued from a financial system of the finance company and incorporating the identification number of the representative payment means into an electronic wallet corresponding to the client's identification number;
(c) downloading an electronic wall driving programing to an web browser on a client terminal if the client requests for the download;
(d) receiving and authenticating the identification number and password from the electronic wallet driving program; and
(e) receiving a client's product purchase information from the electronic wallet driving program, and requesting an approval for payment with the representative payment means to the financial system in response to a payment approval request from the Internet shopping mall, and informing the Internet shopping mall of the result of payment approval request from the financial system.

8. The electronic payment method of claim 8, wherein the representative payment means is a prepaid card.

9. The electronic payment method of claim 7, wherein a client's credit card number or account number is further incorporated into the electronic wallet, the representative payment means is charged by the credit card or from the bank's account number.

10. The electronic payment method of claim 7, further comprising transferring transaction details to the client by e-mail or mobile phone which is selected by the client.

11. An electronic payment method using an anonymous representative payment means issued from a financial company in an Internet shopping mall which is not affiliated with the financial company, the electronic payment method comprising:
(a) providing a identification number and password to a client who applies a registration;
(b) receiving a representative payment means issued from a financial system of the finance company and incorporating the identification number of the representative payment means into an electronic wallet corresponding to the client's identification number;
(c) downloading an electronic wall driving programing to an web browser on a client terminal if the client requests for the download;
(e) receiving and authenticating a client identification number and password from the electronic wallet driving program downloaded to the client terminal to transfer client profile information including the identification number of the representative payment means, which is stored in the electronic wallet of the authenticated client, to the electronic wallet driving program, so that the client profile information is automatically displayed in an input box for payment means information provided by the Internet shopping mall server.
